(19) United States
(12) Patent Application Publication
(10) Pub. No.: US 2026/0298204 A1
(43) Pub. Date: Oct. 1, 2026

(54) APPARATUS AND METHOD FOR TRANSPORTING A WIND TURBINE COMPONENT TO AND/OR AT AN OFFSHORE WIND TURBINE

(71) Applicant: Vestas Wind Systems A/S, Aarhus N. (DK)

(72) Inventor: Adrian Botwright, Sabro (DK)

(73) Assignee: Vestas Wind Systems A/S, Aarhus N. (DK)

(21) Appl. No.: 19/477,825

(22) PCT Filed: Apr. 3, 2024
(86) PCT No.: PCT/DK2024/050078

§ 371 Date: Oct. 23, 2025

(30) Foreign Application Priority Data
Apr. 24, 2023 (DK) PA202370192

(51) Int. Cl. F03D 13/40; B66C 1/10; B66C 23/20; F03D 13/25; F03D 80/50

(52) U.S. Cl. CPC F03D 13/40; B66C 1/108; B66C 23/207; F03D 13/256; F03D 80/50; F05B 2230/6102; F05B 2230/80; F05B 2240/95; F05B 2260/02

(57) ABSTRACT

A transportation system for transporting a wind turbine component (32) on a floating foundation (16) at an offshore wind turbine (10) is provided. The transportation system includes a rail system (52). The rail system (52) includes at least one rail (84) configured to extend from a component landing area (48) to a component lifting area (50) of the floating foundation (16). The transportation system also includes a transportation skid (46) selectively mountable to the rail system (52) and configured to receive the wind turbine component (32). The transportation skid (46) includes a skid frame (54) for supporting the wind turbine component (32) and at least one rail engagement element (60) configured to engage the rail system (52) for moving the transportation skid (46) along the rail system (52). A method of transporting the wind turbine component (32) at the floating foundation (16) of the offshore wind turbine (10), and a method of installing the wind turbine component (32) in the offshore wind turbine (10) are also provided.

### TECHNICAL FIELD

This application relates generally to wind turbines, and more particularly to a transport system and method for moving wind turbine components to and/or at a floating foundation of an offshore wind turbine.

### BACKGROUND

Wind turbines are used to produce electrical energy using a renewable resource and without combusting a fossil fuel. Generally, a wind turbine converts kinetic wind energy into mechanical energy and then subsequently converts the mechanical energy into electrical energy. A common type of wind turbine is the single rotor upwind horizontal-axis wind turbine (HAWT). An exemplary single-rotor HAWT includes a tower, a nacelle located at the apex of the tower, and a single rotor having a central hub and one or more blades mounted to the hub and extending radially therefrom and supported in the nacelle by means of a shaft. The rotor may be coupled either directly or indirectly with a generator housed inside the nacelle and configured to convert the mechanical rotation of the rotor to electrical energy. Consequently, as wind forces the blades to rotate, electrical energy is produced by the generator. Wind turbines may be located either on a land mass (e.g., onshore) or within a body of water (e.g., offshore).

In addition to these components, a wind turbine also includes a number of components for regulating the electrical energy produced by the wind turbine. For example, wind turbines often include a transformer, converter, and other electrical components that regulate the electrical energy so that it may be fed to a power grid in a certain manner. These electrical components can be relatively large, heavy items and are expected to become even larger and heavier as wind turbines and their power production continues to increase. These electrical components are typically located in the nacelle adjacent to, for example, the generator.

The working life of many of these wind turbine components may be less than the working life of the wind turbine. Over time, the wind turbine components, such as the generator, gearboxes, heat exchanges, electrical transformer, and the like, may have to be repaired or replaced. However, it can be difficult, time consuming, and expensive to remove and replace these various components. To facilitate repair or replacement processes, the nacelle may include or be fitted with a crane configured to lower old components from the nacelle to the base of the tower and lift repaired or replacement components up to the nacelle. The process of transporting wind turbine components to and from the base of the tower as well as lifting/lowering the wind turbine components may be relatively straightforward with an onshore wind turbine, as the ground does not move relative to the wind turbine. But, when the wind turbine is offshore, transporting and lowering/lifting wind turbine components can be exceedingly challenging. Specifically, transporting wind turbine components to and at an offshore wind turbine floating foundation can be challenging as the water may be moving relative to the wind turbine and relative to a transport vessel carrying the wind turbine components to the offshore wind turbine.

In existing approaches, transport vessels may physically connect to the wind turbine or floating foundation with elaborate and complex linkages to allow the transport vessel to accommodate the moving water around the wind turbine or floating foundation while the wind turbine components are being lowered and raised by a crane. These elaborate and complex linkages are expensive to design, install, maintain, and operate, which increases the cost of the repair or replacement process. Furthermore, if the water in which the wind turbine or floating foundation resides is turbulent, it may be difficult to safely connect to the wind turbine or floating foundation without possibly damaging the wind turbine.

Accordingly, there is a need in the wind turbine industry for an improved system and method that facilitates replacement or repair of various wind turbine components during the life of an offshore wind turbine. Preferably, the invention avoids, alleviates, mitigates, or otherwise minimizes one or more of the various drawbacks or shortcomings of existing systems and methods for the same.

### SUMMARY

Certain exemplary aspects of the invention are set forth below. It should be understood that these aspects are presented merely to provide the reader with a brief summary of certain forms the invention might take and that these aspects are not intended to limit the scope of the invention.

In a first aspect of the invention, a transportation system for transporting a wind turbine component on a floating foundation of an offshore wind turbine is provided. The floating foundation has a tower interface configured to attach to an end of a wind turbine tower. The transportation system includes a rail system including at least one rail extending from a component landing area to a component lifting area of the floating foundation. The component landing area is spaced from the tower interface of the floating foundation and the component lifting area is located adjacent to the tower interface of the floating foundation. The transportation system further includes a transportation skid selectively mountable to the rail system and is configured to receive the wind turbine component thereon. The transportation skid includes a skid frame for supporting the wind turbine component. At least one rail engagement element is connected to the skid frame and is configured to engage the rail system for moving the transportation skid along the rail system such as from the component landing area to the component lifting area of the floating foundation.

In one embodiment, the at least one rail engagement element may be movable from a stowed position to a deployed position. For example, the at least one rail engagement element may be disengaged from the rail system when in the stowed position and may be engaged with the rail system when in the deployed position. Further, in one embodiment, the at least one rail engagement element may include at least one low-friction pad. In an alternative embodiment, however, the at least one rail engagement element may include at least one roller element. For example, in an exemplary embodiment, the at least one roller element may be at least one wheel.

In one embodiment, the transportation skid may further include a yoke connected to the skid frame for lifting the transportation skid with a lifting device. In this embodiment, for example, the yoke may be configured to allow the wind turbine component to be vertically removed from the skid frame without removing the yoke from the skid frame. In this way, the yoke does not need to be removed from the transportation skid prior to the wind turbine component being removed from the transportation skid by a lifting device. The transportation system may further include a drive system for moving the transportation skid along the rail system. In one embodiment, for example, the drive system may include a drive motor on the transportation skid. In an alternative embodiment, the drive system may include one or more winches connected between the transportation skid and the floating foundation for moving the transportation skid along the rail system.

In another aspect of the invention, an offshore wind turbine site is disclosed and may include a floating foundation having a tower interface, and a transportation system at the floating foundation according to the first aspect described above.

In one embodiment, the component landing area at the floating foundation may include at least one centralizing bore. The at least one centralizing bore may be configured to receive a surface engagement element of the transportation skid to support the transportation skid at the component landing area. In one embodiment, the component landing area at the floating foundation may also include a plurality of bumpers to at least partially define a region of the component landing area configured to receive the transportation skid. The plurality of bumpers may be configured to aid in locating the transportation skid (e.g., through cornering) as the transportation skid is being lowered onto the floating foundation. Furthermore, the component lifting area may further include at least one centralizing bore. In this embodiment, the at least one centralizing bore may be configured to receive a surface engagement element of the transportation skid to support the transportation skid at the component lifting area. The component lifting area may also include a plurality of bumpers to aid in locating the transportation skid at the component lifting area.

In another aspect of the invention, a method of transporting a wind turbine component at a floating foundation of an offshore wind turbine is provided. The floating foundation includes a tower interface configured to attach to an end of a wind turbine tower. The method includes providing the wind turbine component on a transportation skid. The transportation skid and wind turbine component are transported near to the floating foundation by a transport vessel. The method further includes connecting the transportation skid to a lifting device on the transport vessel and, using the lifting device, moving the transportation skid from the transport vessel to a component landing area on the floating foundation. The component landing area is spaced from the tower interface on the floating foundation. The method further includes engaging at least one rail engagement element of the transportation skid with a rail system on the floating foundation. The rail system includes at least one rail extending from the component landing area to a component lifting area at the floating foundation. The component lifting area is located adjacent to the tower interface on the floating foundation. Further, the method includes moving the transportation skid from the component landing area to the component lifting area along the rail system.

In one embodiment, engaging the at least one rail engagement element of the transportation skid with the rail system may include moving the at least one rail engagement element from a stowed position, where the at least one rail engagement element is disengaged from the rail system, to a deployed position, where the at least one rail engagement element is engaged with the rail system. Further, moving the transportation skid from the component landing area to the component lifting area may include activating a drive motor on the transportation skid or activating one or more winches connected between the transportation skid and the floating foundation to facilitate the movement from the component landing area to the component lifting area of the floating foundation.

In another embodiment, the component landing area may include at least one centralizing bore, and moving the transportation skid from the transport vessel to the component landing area may include moving the transportation skid such that at least one surface engagement element of the transportation skid engages with the at least one centralizing bore at the component landing area. Additionally, the method may further include attaching a plurality of bumpers to the component landing area prior to moving the transportation skid from the transport vessel to the component landing area on the floating foundation to aid in locating the transportation skid at the component landing area. In one embodiment, the component lifting area may also include at least one centralizing bore, and the method may further include engaging the at least one surface engagement element on the transportation skid with the at least one centralizing bore at the component lifting area. In one embodiment, the method may further include moving the at least one rail engagement element from the deployed position to the stowed position when the transportation skid is at the component lifting area of the floating foundation.

In yet another aspect of the invention, a method of installing a new or refurbished wind turbine component at an offshore wind turbine site is provided. The offshore wind turbine includes a floating foundation having a tower interface, a wind turbine tower connected to the floating foundation at the tower interface, and a nacelle attached to the tower. The nacelle includes an on-board crane. The method includes transporting the wind turbine component from the transport vessel to the component lifting area according to the third aspect described above, attaching the wind turbine component to the on-board crane of the wind turbine, and lifting the wind turbine component to the nacelle using the on-board crane.

In one embodiment, the method of installing the wind turbine component at the offshore wind turbine site may further include providing another transportation skid at the component lifting area, lowering another wind turbine component from the nacelle (e.g., the old or broken wind turbine component) to the transportation skid using the on-board crane, moving the another transportation skid from the component lifting area to the component landing area along the rail system, connecting the another transportation skid to the lifting device on the transport vessel, and moving the another transportation skid from the component landing area to the transport vessel using the lifting device. In this embodiment, the method may further include moving the at least one rail engagement element from the deployed position to the stowed position when the another transportation skid is at the component landing area.

### BRIEF DESCRIPTION OF THE DRAWINGS

The accompanying drawings, which are incorporated in and constitute a part of this specification, illustrate one or more embodiments of the invention and, together with the Detailed Description given below, serve to explain the one or more embodiments of the invention.

FIG. 1 is a perspective view of an embodiment of an offshore wind turbine with a transport vessel positioned adjacent thereto.

FIG. 2 is a further perspective view of the offshore wind turbine and transport vessel of FIG. 1, showing the vessel transferring a wind turbine component to a floating foundation of the offshore wind turbine.

FIG. 3 is a side view of an embodiment of a transportation skid being lowered onto a component landing area of the offshore wind turbine floating foundation.

FIG. 3A is a plan view of a portion of the transportation skid of FIG. 3.

FIG. 3B is a plan view of the transportation skid of FIG. 3.

FIG. 4 is a further side view of the transportation skid of FIG. 3, showing surface engagement elements of the transportation skid entering centralizing bores at the component landing area of the floating foundation.

FIG. 5 is a further side view of the transportation skid of FIG. 3, showing surface engagement elements fully seated within the centralizing bores at the floating foundation.

FIG. 6 is a further side view of the transportation skid of FIG. 3, showing rail engagement elements extending from the transportation skid and engaging with a rail system on the floating foundation of the offshore wind turbine.

FIG. 7 is a further side view of the transportation skid of FIG. 3, showing the transportation skid moving along the rail system away from the component landing area of the floating foundation.

FIG. 8 is a perspective view of an embodiment of an offshore wind turbine, showing a winch pulling the transportation skid on rails along the floating foundation of the offshore wind turbine.

FIG. 9 is a further perspective view of the offshore wind turbine of FIG. 8, showing the transportation skid located at a component lifting area adjacent the wind turbine tower and an on-board crane engaging with the wind turbine component on the transportation skid.

FIG. 10 is a further perspective view of the offshore wind turbine of FIG. 8, showing the on-board crane lifting the wind turbine component up to the nacelle of the wind turbine.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, this Detailed Description is not meant to limit the scope of the present disclosure.

With reference to the figures generally, embodiments of the invention include apparatuses and methods for transporting a wind turbine component to and at a floating foundation of an offshore wind turbine. Advantageously, the invention described in greater detail below, addresses the issues and complications of exchanging a wind turbine component between a transport vessel and a floating foundation of the offshore wind turbine due to relative movement therebetween caused by the movement of the water in which the wind turbine and transport vessel are located. Other advantages and technical effects of the embodiments of this invention will become evident to one skilled in the art from the following description.

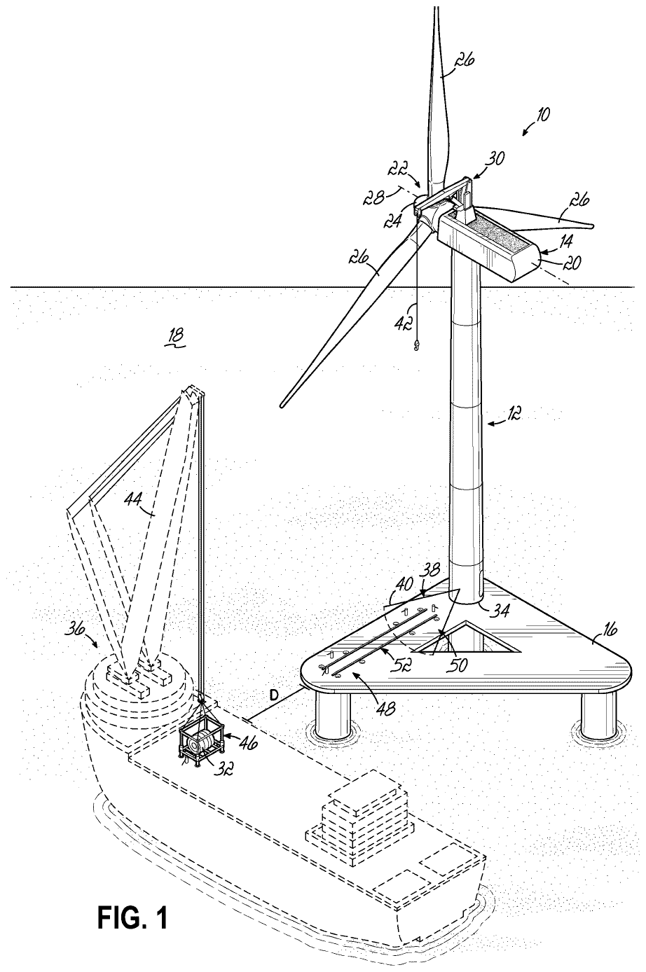

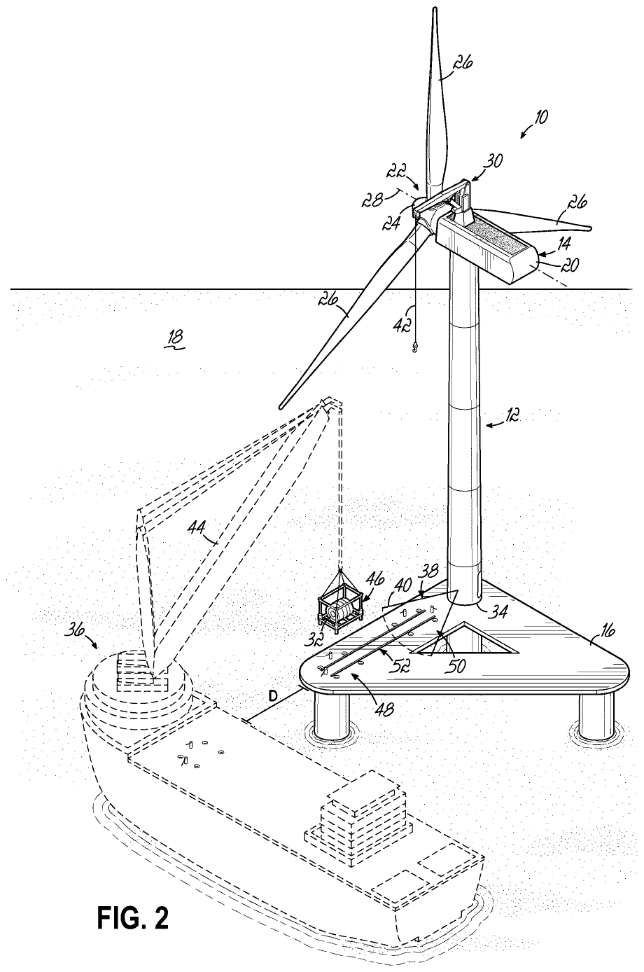

With reference to FIGS. 1 and 2, an exemplary offshore wind turbine 10 is shown. The wind turbine 10, which is represented as a horizontal-axis wind turbine (HAWT), includes a tower 12 and an energy generating unit 14 disposed at the apex of the tower 12. The tower 12 may be coupled to a foundation 16 at a lower end thereof. In the depicted embodiment, the foundation 16 may be a floating foundation generally disposed in a body of water 18. An end of the wind turbine 10 is fixedly secured to the foundation 16 (as described below). A number of floating foundation designs may be used to support the wind turbine 10 including, for example, semisubmersible and barge-type floating foundations. These floating foundations 16 may come in a variety of shapes—triangular, as shown in FIGS. 1 and 2, for example, square, or similar. Further, the position of the wind turbine 10 on the floating foundation 16 may vary. For example, the wind turbine 10 may be located on a corner of the floating foundation 16 (as shown in FIGS. 1 and 2, for example), between adjacent corners on a floating foundation 16, at the center of a floating foundation 16, or similar. Accordingly, aspects of the present invention should not be limited to a certain type of offshore foundation or the location of the wind turbine on the floating foundation.

The tower 12 supports the weight of the energy generating unit 14 and operates to elevate the energy generating unit 14 to a height above sea level at which faster moving air currents of lower turbulence are typically found. The energy generating unit 14 transforms the energy of the wind into electrical energy. The energy generating unit 14 typically includes a housing or nacelle 20, a rotor 22 having a rotor hub 24, and wind turbine blades 26 mounted to the rotor hub 24 extending radially therefrom at locations circumferentially distributed thereabout. In the depicted embodiment, the rotor 22 includes three blades 26, but the number may vary. The blades 26 are configured to interact with the passing air flow to produce lift that causes the rotor hub 24 to spin about a longitudinal axis 28. During operation, the wind produces lift and causes the rotor 22 to spin or rotate to generally define a sweep area of the wind turbine blades 26. The energy generating unit 14 generates power from the wind that passes through the swept area of the rotor 22.

With continued reference to FIGS. 1 and 2, the energy generating unit 14 may further include a drive train with a generator (not shown) for converting mechanical energy into electrical energy, optionally via a gear arrangement (not shown). A substantial portion of the drive train may be positioned inside of the nacelle 20 of the wind turbine 10. In addition to the generator, the nacelle 20 typically houses miscellaneous components required for converting wind energy into electrical energy and various components needed to maintain, operate, control, and optimize the performance of the wind turbine 10.

With continued reference to FIGS. 1 and 2, an on-board (nacelle) crane 30 may be positioned in or on the nacelle 20 and is configured to lift a wind turbine component 32 from a region adjacent a tower interface 34 (e.g., where the tower 12 meets the foundation 16) of the wind turbine tower 12 up to the nacelle 20 or lower a wind turbine component 32 from the nacelle 20 down to adjacent the tower interface 34 of the wind turbine tower 12. For example, the movement of a wind turbine component 32 may be part of a repair or replacement process for the offshore wind turbine 10, as described above. The movement of the wind turbine component 32 may alternatively be part of an original installation of the wind turbine 10. In one embodiment, the on-board crane 30 may permanently reside in or on the nacelle 20. In an alternative embodiment, however, the on-board crane 30 may be temporary and connected to the nacelle 20 for the specific purpose of installing or replacing the wind turbine component 32.

A transport vessel 36 may be positioned near to the foundation 16 and wind turbine 10. The transport vessel 36 does not need to be physically attached to the foundation 16 or wind turbine 10 to replace or install wind turbine components 32 from the wind turbine 10. This is in contrast to many existing arrangements where the system for handling the wind turbine components 32 is connected directly to the wind turbine 10. Instead. the transport vessel 36 may be located a distance, D, from the closest portion of the foundation 16.

With continued reference to FIGS. 1 and 2, the on-board crane 30 on the nacelle 20 has a working zone 38 in which the on-board crane 30 can lift or lower wind turbine components 32 to or from the nacelle 20. The outer most perimeter of the working zone 38 is a maximum working distance 40, which is the farthest distance that a lift line 42 of the on-board crane 30 can reach. The distance D of the transport vessel 36 from the foundation 16 is greater than the maximum working distance 40 of the on-board crane 30 such that the transport vessel 36 is outside of the working zone 38 of the on-board crane 30. Thus, it is not possible for the on-board crane 30 to directly access the transport vessel 36.

Instead, and in reference to FIG. 2, the wind turbine component 32 may be initially transported by a lifting device on the transport vessel 36 (e.g., by a vessel crane 44 or similar) from the transport vessel 36 to the foundation 16, outside of the working zone 38 of the on-board crane 30. More particularly, the wind turbine component 32 may be transported on a transportation skid 46 by the vessel crane 44 to a component landing area 48 of the floating foundation 16. The component landing area 48 is generally outside the working zone 38 of the on-board crane 30 and is spaced a distance from the tower interface 34 (e.g., where the tower 12 meets the foundation 16). In contrast, a component lifting area 50 may be located near to (e.g., adjacent) the tower interface 34. Specifically, the component lifting area 50 may be located within the working zone 38 of the on-board (nacelle) crane 30 such that a wind turbine component 32 at the component lifting area 50 can be accessed by the on-board (nacelle) crane 30. Moreover, in an exemplary embodiment according to the invention, a rail system 52 may extend between and connect the component landing area 48 and the component lifting area 50 of the floating foundation 16. The transportation skid 46 (which carries the wind turbine component 32 from the transport vessel 36) is configured to be selectively mountable to the rail system 52. For example, utilizing the rail system 52, the wind turbine component 32 may be moved (e.g., transported) on the transportation skid 46 between the component landing area 48 and the component lifting area 50 of the floating foundation 16.

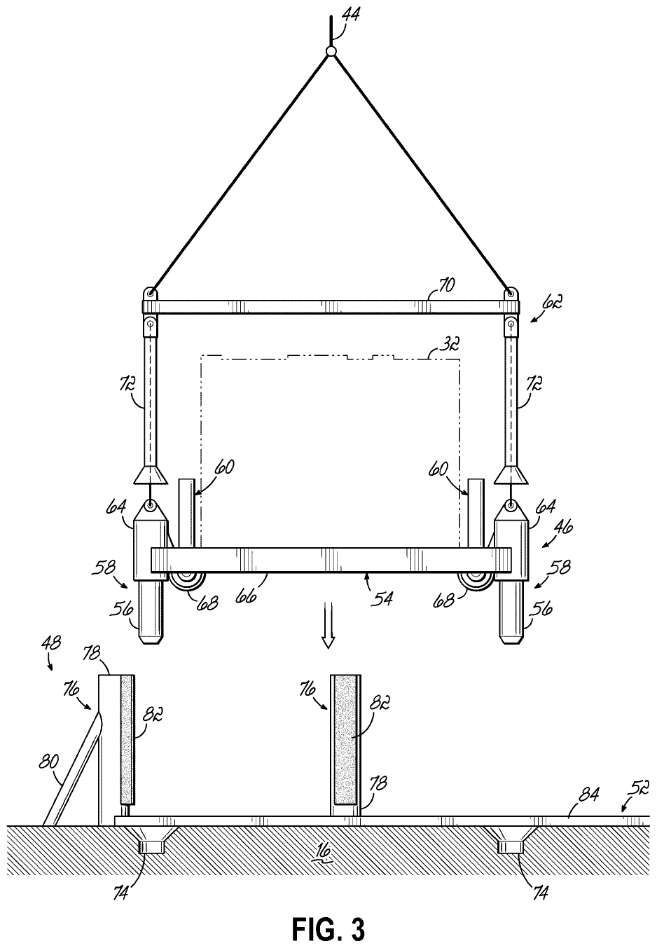

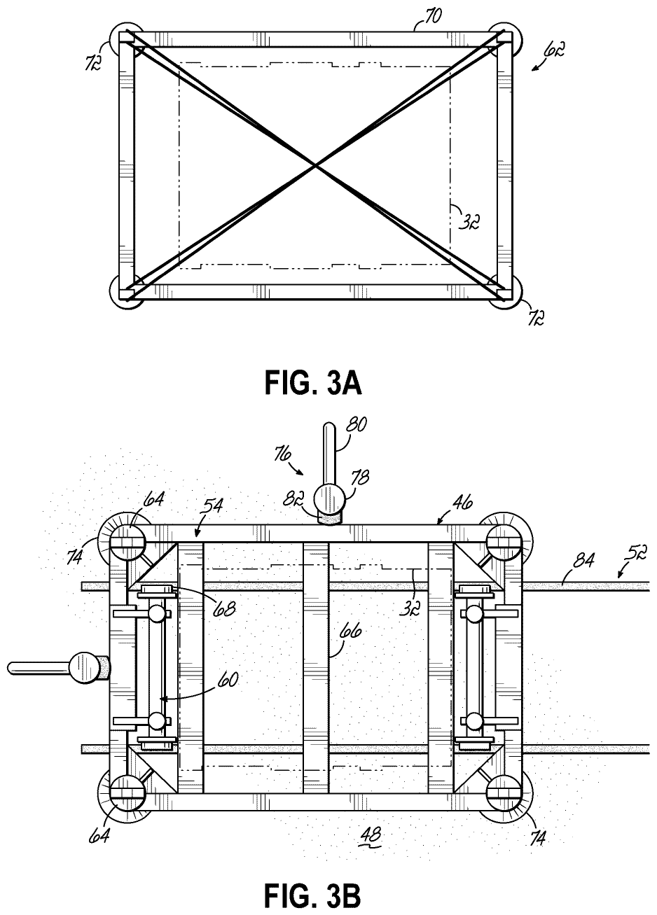

Referring now to FIGS. 3-3B, the figures show an embodiment of the transportation skid 46 for transporting the wind turbine component 32 to and at the floating foundation 16 of the offshore wind turbine 10. The transportation skid 46 is multi-purpose and supports routine maintenance of the wind turbine 10 as well as main component installment or replacement. Thus, the transportation skid 46 is adaptable depending on the particular wind turbine component 32 to be transported. As described in greater detail below, in an exemplary embodiment, the transportation skid 46 may generally include a skid frame 54, at least one surface engagement element 56, at least one shock absorber 58, at least one rail engagement element 60, and a yoke 62.

In this embodiment, the skid frame 54 of the transportation skid 46 is configured to provide support for the wind turbine component 32 located on the transportation skid 46. In one embodiment, for example, the skid frame 54 may include a number of posts 64 connected by connecting beams 66 to define a lattice structure (e.g., rectilinear) of the skid frame 54. For example, the transportation skid 46 depicted in FIGS. 3-3B may include four posts 64. In this embodiment, each post 64 may be arranged at a corner of the transportation skid 46. It is to be understood that, in an alternative embodiment, the transportation skid 46 may include fewer or more than four posts 64 and the posts 64 may be alternatively arranged. The posts 64 may be connected to each other by one or more connecting beams 66. For example, in one embodiment, the transportation skid 46 depicted in FIGS. 3-3B may include four connecting beams 66. In this embodiment, two connecting beams 66 may extend (e.g., orthogonally to each other) from each post 64 such that each connecting beam 66 connects two posts 64 located at opposing corners of the transportation skid 46. It is to be understood that, in an alternative embodiment, the transportation skid 46 may include fewer or more connecting beams 66 and the connecting beams 66 may be alternatively arranged (e.g., in an “X” or “Z” arrangement).

With continued reference to FIGS. 3-3B, surface engagement elements 56 of the transportation skid 46 are configured to engage the component landing area 48 at the floating foundation 16 of the offshore wind turbine 10. When the transportation skid 46 is lowered (e.g., by the vessel crane 44) onto the component landing area 48 of the floating foundation 16, at least one surface engagement element 56 of the transportation skid 46 engages with the component landing area 48 of the floating foundation 16. In the depicted embodiment, the transportation skid 46 may include four surface engagement elements 56 which engage with the component landing area 48 of the floating foundation 16. However, it is to be understood that the transportation skid 46 may include fewer or more than four surface engagement elements 56. In an exemplary embodiment, the at least one shock absorber 58 connects the at least one surface engagement element 56 with the skid frame 54. In one embodiment, for example, the at least one surface engagement element 56 may be defined by a portion of the at least one shock absorber 58. In an alternative embodiment, however, the at least one shock absorber 58 may be disposed between the at least one surface engagement element 56 and the skid frame 54. In the depicted embodiment, the transportation skid 46 may include four shock absorbers 58 (e.g., one shock absorber 58 for each surface engagement element 56). However, it is to be understood that the transportation skid 46 may include fewer or more than four shock absorbers 58.

According to aspects of the invention, the shock absorbers 58 are configured to soften the landing of the transportation skid 46 on the component landing area 48 during delivery of the wind turbine component 32 to the floating foundation 16. Such is particularly helpful in the context of a floating foundation 16 because of the inherent motions of the transport vessel 36 (from which the transportation skid 46 is being transferred) and floating foundation 16 (to which the transportation skid 46 is being transferred in the body of water). More particularly, the at least one shock absorber 58 absorbs impacts (e.g., caused by relative motion of the transport vessel 36 and the floating foundation 16) of at least one surface engagement element 56 of the transportation skid 46 with the component landing area 48 to soften the landing of the transportation skid 46 on the floating foundation 16. By way of example, the at least one shock absorber 58 may be a hydraulic arrester, a resilient isolator (e.g., a spring, elastomeric element, etc.), a selectively inflatable element (e.g., cushion, tube, or shape), or similar, for example. If the at least one shock absorber 58 is an inflatable element (e.g., when the impact forces are less extreme), the inflatable element may be attached to an underside of the skid frame 54 and/or on a perimeter of the skid frame 54. The selectively inflatable element(s) may be inflated or deflated as desired. It is to be understood that the at least one shock absorber 58 may take on further alternative forms and remain within the scope of the invention.

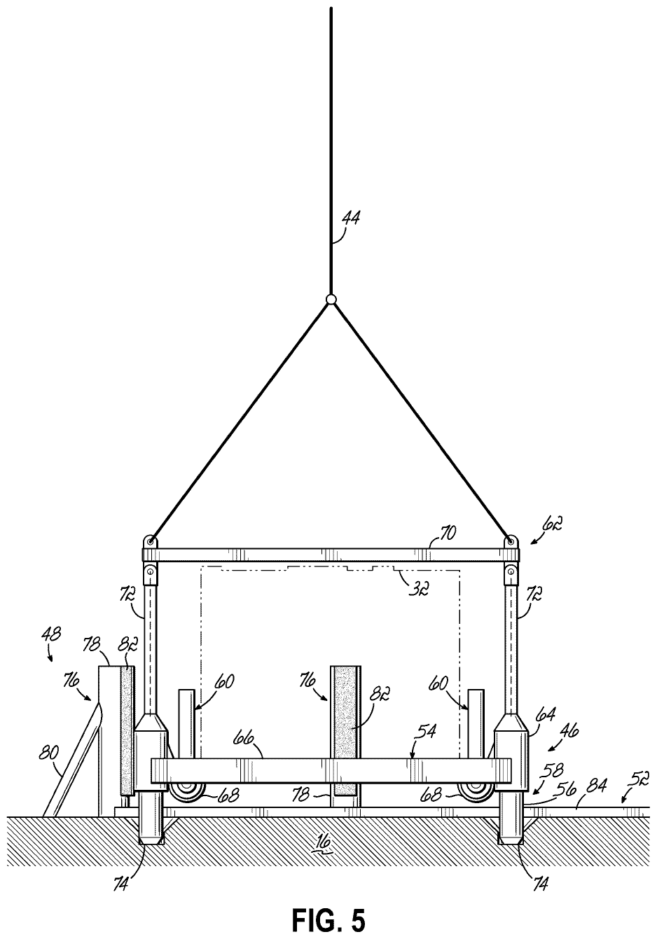

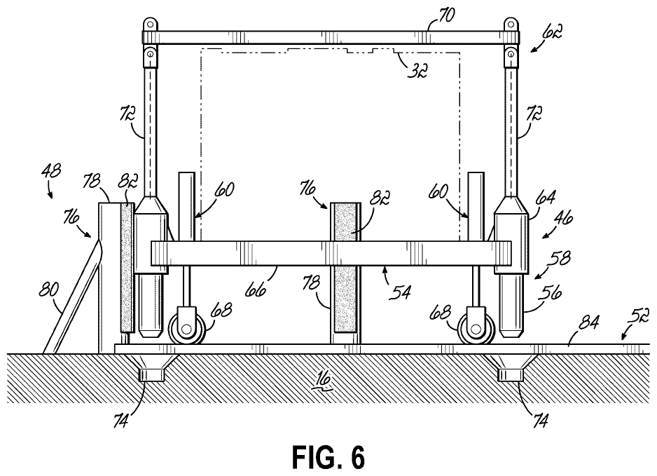

With continued reference to FIGS. 3-3B, the transportation skid 46 may include at least one rail engagement element 60. The rail engagement element 60 is connected to the skid frame 54 and is configured to engage the rail system 52 for moving the transportation skid 46 along the rail system 52, such as between the component landing area 48 and the component lifting area 50, for example. In the depicted embodiment, the transportation skid 46 may include four rail engagement elements 60. However, it should be understood that the transportation skid 46 may include fewer or more than four rail engagement elements 60. By way of example, the rail engagement element 60 may include a low-friction pad, a roller element 68, or similar. In the depicted embodiment, the rail engagement element 60 may be a roller element 68, such as a wheel. However, it is to be understood that the rail engagement element 60 may take on further alternative forms. As will be described in greater detail below, the at least one rail engagement element 60 may be movable between a stowed position (as shown in FIG. 5, for example) and a deployed position (as shown in FIG. 6, for example). In the stowed position, the rail engagement element 60 may be disengaged from the rail system 52 and in the deployed position, the rail engagement element 60 may be engaged with the rail system 52.

In one embodiment, the transportation skid 46 may include a yoke 62. The yoke 62 may be removably attached to the skid frame 54 and facilitates lifting of the transportation skid 46 by a lifting device (e.g., a vessel crane 44, on-board (nacelle) crane 30, or similar). Specifically, the lifting device may connect to the yoke 62 and the yoke 62 may connect to the skid frame 54. In one embodiment, the yoke 62 may include a yoke frame 70 for attachment to the lifting device. The yoke 62 may also include at least one leg 72 connected to the yoke frame 70. In the depicted embodiment, the yoke 62 may include four legs 72. However, it should be understood that the yoke 62 may include fewer or more than four legs 72. The at least one leg 72 is configured to engage the skid frame 54.

More particularly, in the depicted embodiment, each of the legs 72 of the yoke 62 may be coupled to a respective one of the posts 64 of the skid frame 54. In an exemplary embodiment, the at least one leg 72 may be movable between a folded position and an extended position. In the folded position, the at least one leg 72 may be disengaged from the skid frame 54 and positioned adjacent to the yoke frame 70 so that the yoke 62 has a compact configuration (e.g., a generally planar configuration) to facilitate storage and transport when the yoke is not in use. In the deployed position, the at least one leg 72 may be configured to extend from the yoke frame 70 and engage with the skid frame 54, such as at posts 64. Thus, the yoke frame 70 and the skid frame 54 may be vertically separated at least by the length of the at least one leg 72. The length of the at least one leg 72 may be selected such that the wind turbine component 32 fits between the yoke frame 70 and skid frame 54. However, other lengths of the at least one leg 72 may also be possible.

With continued reference to FIGS. 3-3B, when the legs 72 of the yoke 62 are in the deployed position and the legs 72 attached to the skid frame 54, the yoke 62 may be self-supporting. In other words, the legs 72 support the yoke frame 70 when the lifting equipment (e.g., vessel crane 44 or on-board (nacelle) crane 30) is slacked or disconnected from the yoke 62 such that the yoke 62 does not collapse onto the transportation skid 46. More particularly, the yoke 62 may be attached to the skid frame 54 by yoke cables that extend through an interior of the legs 72. The yoke cables extend through the legs 72 and attach to the posts 64 of the skid frame 54 via connector plates atop the respective posts 64, for example (FIG. 3). When the yoke cables are slacked (e.g., when the yoke 62 is not connected to lifting equipment such as the vessel crane 44), the legs 72 support the weight of the yoke 62. The yoke 62 being self-supporting may allow for the wind turbine component 32 (e.g., on the transportation skid 46) to be vertically removed from the skid frame 54 without removing the yoke 62 from the skid frame 54. For example, when the transportation skid 46 is located at the component lifting area 50 (e.g., within the working zone 38 of the floating foundation 16), the on-board (nacelle) crane 30 may be configured to lift the wind turbine component 32 from the transportation skid 46 utilizing the lift line 42 without removing the yoke 62 from the transportation skid 46. The yoke 62 being self-supporting may also allow for the yoke 62 to be safely disconnected from the vessel crane 44 when the transportation skid 46 is at the component landing area 48, for example, while the transport vessel 36 and floating foundation 16 are moving relative to each other.

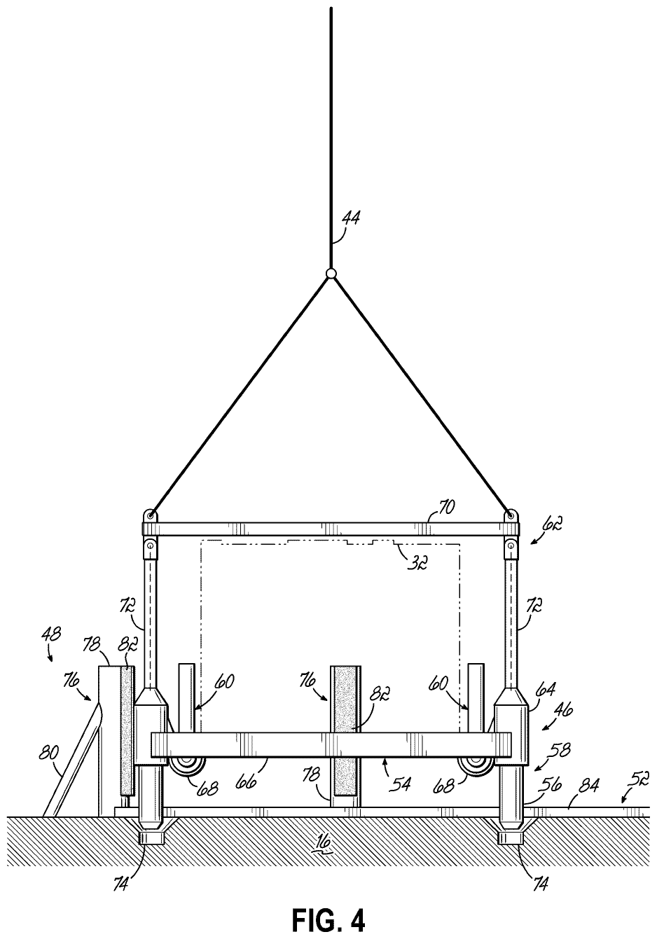

Referring now to FIGS. 4 and 5, the figures show an embodiment of the transportation skid 46 being lowered toward the component landing area 48 of the floating foundation 16. As shown, the component landing area 48 of the floating foundation 16 includes a number of features to facilitate the landing of the transportation skid 46 upon the floating foundation 16. For example, as described in greater detail below, the component landing area 48 may include at least one centralizing bore 74 and a plurality of bumpers 76 that at least partially define the component landing area 48. Alternatively or additionally, the component landing area 48 may include selectively inflatable elements to act as shock absorbers (e.g., when the impact forces are less extreme). The selectively inflatable element(s) may be inflated or deflated as desired. The component landing area 48 may also include a portion of the rail system 52 to move the transportation skid 46 from the component landing area 48 to the component lifting area 50 of the floating foundation 16.

The at least one centralizing bore 74 at the component landing area 48 of the floating foundation 16 is configured to receive a surface engagement element 56 of the transportation skid 46 to support the transportation skid 46 thereon. In the depicted embodiment, the centralizing bores 74 may be located in the surface of the floating foundation 16. However, it is to be understood that the centralizing bores 74 may be alternatively configured. For example, in an alternative embodiment, the centralizing bores 74 may be located in an intermediate structure supported on the floating foundation 16 instead of being formed directly in the surface of the floating foundation 16. Moving the transportation skid 46 from the transport vessel 36 to the component landing area 48 includes moving the transportation skid 46 such that at least one surface engagement element 56 on the transportation skid 46 engages with the at least one centralizing bore 74 at the component landing area 48 of the floating foundation 16. More specifically, the transportation skid 46 is lowered (e.g., by the vessel crane 44) to engage the at least one surface engagement element 56 of the transportation skid 46 with the at least one centralizing bore 74 at the component landing area 48. Engaging the at least one surface engagement element 56 with the at least one centralizing bore 74 prevents the transportation skid 46 from sliding due to motions of the floating foundation 16, for example. In the depicted embodiment, the centralizing bores 74 may be cone-shaped to guide the at least one surface engagement element 56 into the at least one centralizing zone 74 as the wind turbine component is being lowered toward the floating foundation 16. However, it is to be understood that the centralizing bores 74 may be alternatively shaped.

With continued reference to FIGS. 4 and 5, in the depicted embodiment, the transportation skid 46 may include a plurality of surface engagement elements 56 and the component landing area 48 may include a plurality of centralizing bores 74. The centralizing bores 74 provide for fine alignment of the transportation skid 46 within the component landing area 48 by the vessel crane 44, for example. In other words, seating the transportation skid 46 in the centralizing bores 74 indicates to an operator of the vessel crane 44, for example, that the transportation skid 46 is correctly positioned at the component landing area 48 to engage with rail system 52. More particularly, the depicted transportation skid 46 may include four surface engagement elements 56 and the component landing area 48 may include four centralizing bores 74. However, it is to be understood that the transportation skid 46 and the component landing area 48 may include fewer or more than four surface engagement elements 56 and centralizing bores 74. Each of the plurality of surface engagement elements 56 on the transportation skid 46 may engage with a respective one of the plurality of centralizing bores 74 in the component landing area 48 of the floating foundation 16. As shown in FIG. 5, for example, the surface engagement elements 56 may bottom out in the centralizing bores 74 when the transportation skid 46 is lowered completely onto the component landing area 48 of the floating foundation 16.

In one embodiment, the component landing area 48 may further include a plurality of bumpers 76 that, at least partially, define a region of the component landing area 48 configured to receive the transportation skid 46. Where the centralizing bores 74 provide for fine alignment of the transportation skid 46 (as described above), the bumpers 76 may provide for coarse alignment of the transportation skid 46 within the component landing area 48 by the vessel crane 44, for example. In other words, the bumpers 76 may indicate to an operator of the vessel crane 44, for example, that the transportation skid 46 is roughly correctly positioned within the component landing area 48. Such is particularly helpful in the context of a floating foundation 16 because of the inherent motions of the transport vessel 36 (from which the transportation skid 46 is being transferred) and floating foundation 16 (to which the transportation skid 46 is being transferred).

With continued reference to FIGS. 4 and 5, the bumpers 76 may be attached to the component landing area 48 prior to moving the transportation skid 46 from the transport vessel 36 to the component landing area 48 of the floating foundation 16. In the depicted embodiment, the component landing area 48 may include two bumpers 76. In one embodiment, the bumpers 76 may be arranged so as to contact two adjoining sides of the transportation skid 46 to enable “cornering” of the transportation skid 46 with the bumpers 76 as the transportation skid 46 is being lowered toward the component landing area 48 (e.g., prior to the surface engagement elements 56 engaging the centralizing bores 74). It is to be understood that, in an alternative embodiment, the component landing area 48 may include fewer or more bumpers 76 and the bumpers 76 may be alternatively arranged. In one embodiment, each bumper 76 may include a bumper post 78 that may be supported by a bumper support 80. The bumper post 78 and bumper support 80 may be made of steel, for example. Further, the bumper post 78 may include bumper facing 82. The bumper facing 82 may be rubber or other material configured to dampen impact on the bumper 76 from the transportation skid 46 being lowered toward the component landing area 48 of the floating foundation 16. Alternatively or additionally, selectively inflatable elements could be attached to the bumper posts 78 in addition to or as a substitute for (rubber, for example) bumper facing 82. The selectively inflatable element(s) may be inflated or deflated as desired.

As noted above, the component landing area 48 may include a portion of the rail system 52. The rail system 52 on the floating foundation 16 allows the transportation skid 46 to move from the component landing area 48 (to the component lifting area 50, for example). In an exemplary embodiment, the rail system 52 may include at least one rail 84 mounted to the surface of the floating foundation 16. The at least one rail 84 may extend between the component landing area 48 and the component lifting area 50 of the floating foundation 16. In the depicted embodiment, the rail system 52 may include a pair of spaced apart generally parallel rails 84. The rails 84 may be flat or, alternatively, the rails 84 may be tubular in shape. Each rail 84 may be substantially the same and in a further alternative embodiment, may be configured as an I-beam having an upper plate member, a lower plate member, and a generally centrally located intermediate web connecting the upper and lower plate members, for example. Additionally, each of the rails 84 may be unitary or monolithic structures, and therefore be substantially continuous in the longitudinal direction. In an alternative embodiment, however, each of the rails 84 may have a modular design comprising a plurality of rail segments (not shown) coupled in an end-to-end fashion to collectively form the rails 84. This may allow the rail system 52 to be more easily stored on the floating foundation 16 or stowed on board the transport vessel 36 that provides maintenance to the wind turbine 10. The rails 84 may be made out of steel or other suitable materials sufficient to handle the loads being imposed thereon during use of the rail system 52.

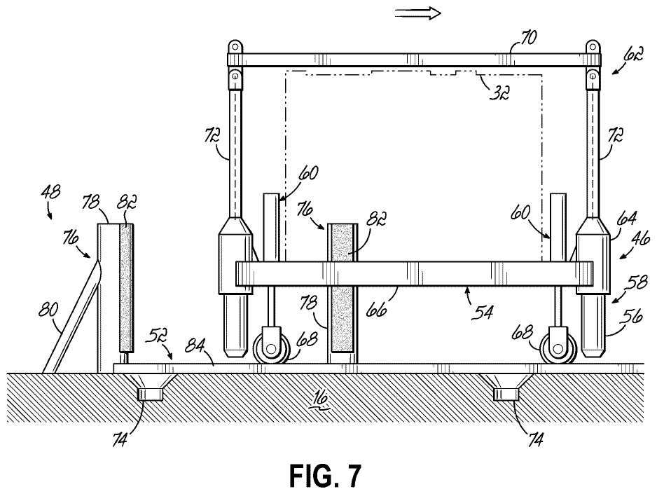

With continued reference to FIGS. 4 and 5, it is to be understood that the rail system 52 may take on further alternative forms. For example, the rail system 52 may be a hydraulic skidding system where a skid beam (or series of skid beams) is moved by push-pull cylinders (e.g., hydraulic) over a constructed track. One potential advantage of a hydraulic skidding system is the ability to install the system as needed (as opposed to permanently) which helps to minimize corrosion and maintenance. For example, as described in greater detail below with respect to FIGS. 6 and 7, the at least one rail engagement element 60 of the transportation skid 46 may be configured to engage with the rail system 52, and specifically the rail 84, on the floating foundation 16 to move the transportation skid 46 (and the wind turbine component 32 thereon) between the component landing area 48 and the component lifting area 50.

Referring now to FIGS. 6 and 7, the figures illustrate engagement of the at least one rail engagement element 60 of the transportation skid 46 with the rail system 52 (FIG. 6) and movement of the transportation skid 46 along the rail system 52 towards the component lifting area 50, for example (FIG. 7). As previously described, the transportation skid 46 may be lowered by the vessel crane 44, for example, to the component landing area 48 and positioned adjacent to the rail system 52. In an exemplary embodiment, the at least one rail engagement element 60 may be movable between a stowed position and a deployed position. In the stowed position, the at least one rail engagement element 60 may be disengaged from the rail system 52 and, in the deployed position, the at least one rail engagement element 60 may be engaged with the rail system 52.

In the depicted embodiment, the rail engagement element 60 may transition from the stowed position to the deployed position by extending from a bottom of the transportation skid 46 by an extendable (e.g., hydraulic) cylinder, for example. It should be understood, that the rail engagement element 60 may transition from the stowed position to the deployed position in alternative manners. For example, the rail engagement element 60 could flip down from the transportation skid 46 into engagement with the rail system 52. Alternatively, the at least one surface engagement element 56 may retract (e.g., from the position in which the surface engagement element 56 makes contact with the centralizing bore 74 and/or floating foundation 16) so that the rail engagement element 60, and specifically the roller element 68, may engage with the rail system 52. For example, if the at least one shock absorber 58 is a selectively inflatable element, then the inflatable element may be deflated so that the rail engagement element 60, and specifically the roller element 68, may engage with the rail system 52. In any event, with the rail engagement element 60 in the deployed position and engaged with the rail system 52, the transportation skid 46 can move from the component landing area 48 to the component lifting area 50 along the rail system 52.

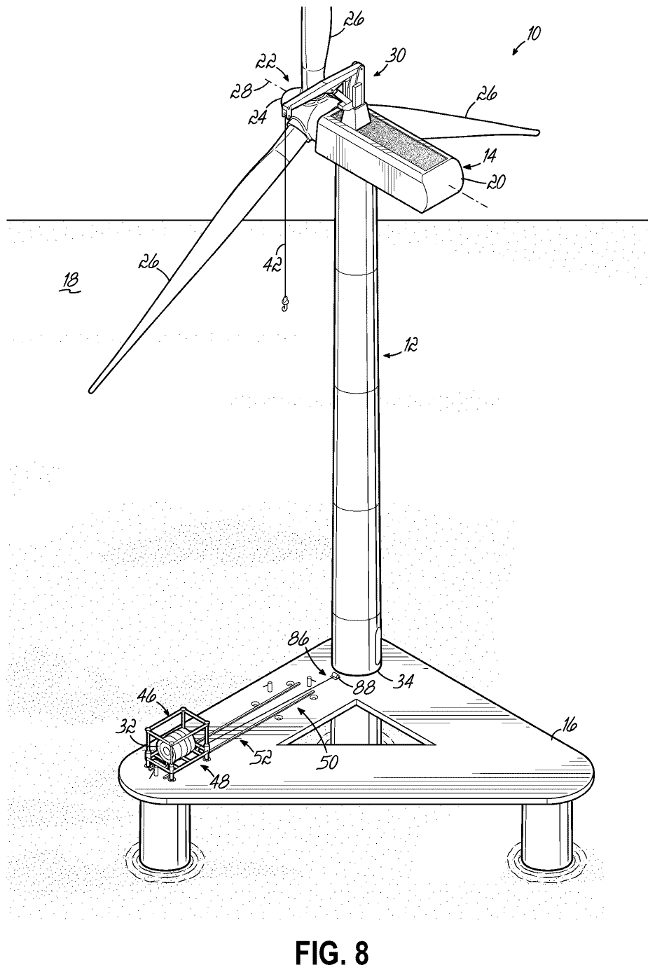

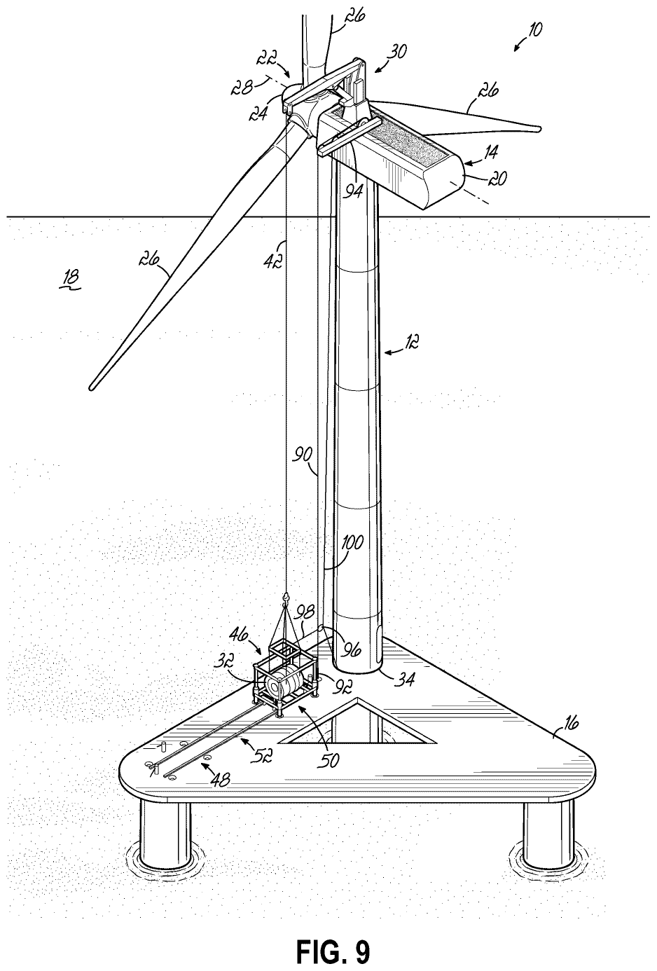

Referring now to FIGS. 8-10, the figures illustrate the transportation skid 46 moving from the component landing area 48 to the component lifting area 50 (FIGS. 8 and 9) and the wind turbine component 32 being lifted from the transportation skid 46 at the component lifting area 50. After the transportation skid 46 with the wind turbine component 32 is lifted from the transport vessel 36 to the component landing area 48 (e.g., by the vessel crane 44), the transportation skid 46 may be moved across the floating foundation 16 from the component landing area 48 spaced from the wind turbine tower 12 to the component lifting area 50 adjacent the wind turbine tower 12, for example.

To move the transportation skid 46 from the component landing area 48 along the rail system 52, a drive system 86 may be utilized. In the embodiment depicted in FIG. 8, the drive system 86 may be a winch 88 connected between the transportation skid 46 and the floating foundation 16. When activated, the winch 88, located on the floating foundation 16 in the figure, is configured to pull the transportation skid 46 from the component landing area 48 (after the rail engagement element 60 has been deployed and engages the rail system 52) to the component lifting area 50, for example. It is to be understood that the winch 88 could be alternatively located on the transportation skid 46, for example, instead of being located on the floating foundation 16. Further, it is envisioned that a competing winch (not shown) may be deployed (on the floating foundation 16 or on the transportation skid 46, for example) to pull the transportation skid 46 from the component lifting area 50 back to the component landing area 48 (e.g., after the wind turbine component 32 has been removed from the transportation skid 46). Furthermore, it is to be understood that alternative drive systems 86 may be employed (e.g., screw, rack and pinion system, etc.). As a specific example, the transportation skid 46 may be self-powered and, in such an embodiment, the drive system 86 may include a drive motor (not shown) located on the transportation skid 46 that, when activated, drives the roller elements 68 and facilitates movement of the transportation skid 46 along the rail system 52 (e.g., between the component landing area 48 and the component lifting area 50).

With specific reference to FIG. 8, the figure shows the component lifting area 50 of the floating foundation 16. The component lifting area 50 may be arranged much the same as the previously described component landing area 48. More particularly, in the depicted embodiment, the component landing area 48 may include four centralizing bores 74 (e.g., configured and arranged to receive the surface engagement elements 56 of the transportation skid 46) and two bumpers 76 (e.g., arranged to enable cornering of the transportation skid 46). However, it is to be understood that, in alterative embodiments, the component lifting area 50 could be alternatively arranged. When the transportation skid 46 arrives at the component lifting area 50, the at least one rail engagement element 60 may be moved from the deployed position (e.g., in which the rail engagement element 60 engages with the rail system 52) to the stowed position (e.g., in which the rail engagement element 60 does not engage with the rail system 52). In so doing, the transportation skid 46 may be prepared for the wind turbine component 32 to be removed from the transportation skid 46.

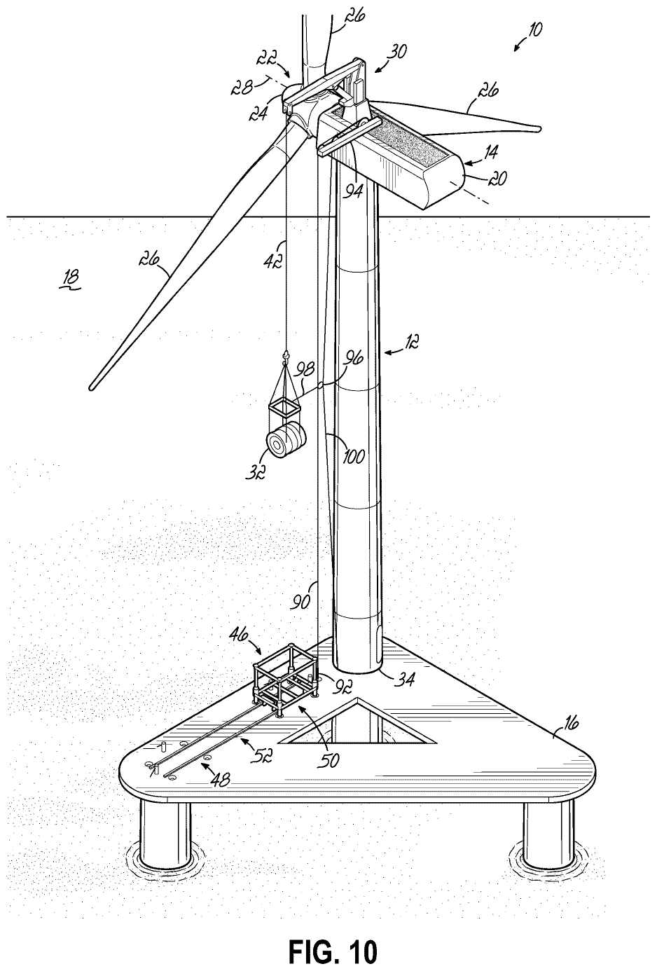

With specific reference to FIGS. 9 and 10, the figures illustrate lifting a wind turbine component 32 from the transportation skid 46 at the component lifting area 50 to the nacelle 20 of the wind turbine 10 by the on-board (nacelle) crane 30. To facilitate lifting the wind turbine component 32, the component lifting area 50 may include one or more guide wires 90 to guide and help stabilize (e.g., prevent the wind turbine component 32 from rotating, twisting, or contacting the tower 12 of the wind turbine 10) the wind turbine component 32 when lifted or lowered between the floating foundation 16 and nacelle 20. Each guide wire 90 may be connected at one end (e.g., bolted or similar) to the floating foundation 16 by an anchor point 92. Alternatively, the anchor point 92 may be located on a bumper 76 at the component lifting area 50. Each guide wire 90 may be connected at an opposite end to the nacelle 20 of the wind turbine 10 by a guide wire beam 94. The guide wire beam 94 may extend from the nacelle 20 in the direction of the component lifting area 50. Each guide wire 90 may be tensioned (e.g., by winch, cylinder, bottle screw, capstan, or similar) between the guide wire beam 94 and an anchor point 92. If it is necessary for the nacelle 20 to yaw, the one or more guide wires 90 may be disconnected from the anchor point 92 (and/or the guide wire beam 94).

In one embodiment, a traveling block 96 may be located on and is configured to run up and down a guide wire 90. A strap 98 may extend between the traveling block 96 (e.g., on the guide wire 90) and the load to be lifted by the lift line 42 (e.g., the wind turbine component 32) to secure the load to the traveling block 96 (and the guide wire 90). In alternative embodiments, there may be multiple lift lines 42. A handling rope 100 may be attached at an end to the guide wire beam 94 and further attached to the traveling block 96 to allow an operator to manipulate the traveling block 96. More particularly, the handling rope 100 may move the traveling block 96 (and the attached load, e.g., the wind turbine component 32) along the guide wire 90 between the component lifting area 50 on the floating foundation 16 and the nacelle 20 of the wind turbine 10.

With general reference to FIGS. 8-10, the general process described above for transporting the wind turbine component 32 from the transport vessel 36 located near to a floating foundation 16 to the nacelle 20 of the wind turbine 10 on the floating foundation 16 may be reversed, i.e., to remove a wind turbine component 32 from the wind turbine 10. For example, another transportation skid 46 may be stored on the floating foundation 16 (e.g., in or on a stand located adjacent or near to the component lifting area 50) until such a time when the another transportation skid 46 is needed. When needed, the another transportation skid 46 may be provided at the component lifting area 50. A wind turbine component 32 (e.g., an old or broken wind turbine component from the nacelle 20) may then be lowered to the another transportation skid 46 using the on-board (nacelle) crane 30.

Thereafter, the another transportation skid 46 may be moved from the component lifting area 50 to the component landing area 48 along the rail system 52 in the manner discussed above. Upon arrival at the component landing area 48, the at least one rail engagement element 60 may be moved from a deployed position (e.g., engaging with the rail system 52) to a stowed position (e.g., not engaging with the rail system 52) to prepare the another transportation skid 46 to be transported away from the floating foundation 16. A lifting device (e.g., vessel crane 44) may then connect to the another transportation skid 46 (e.g., via the attached yoke 62) and move the transportation skid 46 from the component landing area 48 of the floating foundation 16 to the transport vessel 36. In this way, the described transportation system allows for wind turbine components 32 to be moved in both directions between the transport vessel 36 and the nacelle 20 of the offshore wind turbine 10 on the floating foundation 16.

While the present invention has been illustrated by the description of various embodiments and while these embodiments have been described in some detail, it is not the intention of the Applicant to restrict or in any way limit the scope of the invention to such detail. Additional advantages and modifications will readily appear to those skilled in the art. The invention in its broader aspects is therefore not limited to the specific details and illustrative examples shown and described. Accordingly, departures may be made from such details without departing from the scope of the general inventive concept. Various features of the invention may be used alone or in any combination depending on the needs and preferences of the user.

1. A transportation system for transporting a wind turbine component at a floating foundation of an offshore wind turbine, the floating foundation having a tower interface configured to attach to an end of a wind turbine tower, the transportation system comprising:
a rail system including at least one rail configured to extend from a component landing area to a component lifting area of the floating foundation, the component landing area being spaced from the tower interface of the floating foundation and the component lifting area being adjacent the tower interface of the floating foundation; and
a transportation skid selectively mountable to the rail system and configured to receive the wind turbine component, the transportation skid comprising:
a skid frame for supporting the wind turbine component; and
at least one rail engagement element connected to the skid frame and configured to engage the rail system for moving the transportation skid along the rail system.

2. The transportation system of claim 1, wherein the at least one rail engagement element is movable from a stowed position to a deployed position, the at least one rail engagement element configured to be disengaged from the rail system when in the stowed position and configured to be engaged with the rail system when in the deployed position.

3. The transportation system of claim 1, wherein the transportation skid further comprises a yoke configured to be attachable to the skid frame for lifting of the transportation skid with a lifting device, the yoke configured to allow the wind turbine component to be vertically removed from the skid frame without removing the yoke from the skid frame.

4. The transportation system of claim 1, further comprising a drive system for moving the transportation skid along the rail system, the drive system including a drive motor on the transportation skid or one or more winches configured to be connected between the transportation skid and the floating foundation.

5. An offshore wind turbine site, comprising:
a floating foundation having a tower interface; and
the transportation system of claim 1 on the floating foundation.

6. The offshore wind turbine site of claim 5, wherein the component landing area includes at least one centralizing bore, the at least one centralizing bore configured to receive a surface engagement element of the transportation skid to support the transportation skid at the component landing area.

7. The offshore wind turbine site of claim 5 , wherein the component landing area includes a plurality of bumpers to at least partially define a region of the component landing area configured to receive the transportation skid.

8. The offshore wind turbine site of claim 5, wherein the component lifting area includes at least one centralizing bore, the at least one centralizing bore configured to receive a surface engagement element of the transportation skid to support the transportation skid at the component lifting area.

9. A method of transporting a wind turbine component at a floating foundation of an offshore wind turbine, the floating foundation having a tower interface configured to attach to an end of a wind turbine tower, the method comprising:
providing the wind turbine component on a transportation skid, the transportation skid and wind turbine component transported near to the floating foundation on a transport vessel;
connecting the transportation skid to a lifting device on the transport vessel;
using the lifting device, moving the transportation skid from the transport vessel to a component landing area on the floating foundation, the component landing area being spaced from the tower interface on the floating foundation;
engaging at least one rail engagement element of the transportation skid with a rail system on the floating foundation, the rail system including at least one rail extending from the component landing area to a component lifting area, the component lifting area being adjacent the tower interface on the floating foundation; and
moving the transportation skid from the component landing area toward the component lifting area along the rail system.

10. The method of claim 9, wherein engaging the at least one rail engagement element of the transportation skid with the rail system includes moving the at least one rail engagement element from a stowed position, where the at least one rail engagement element is disengaged from the rail system, to a deployed position, where the at least one rail engagement element is engaged with the rail system.

11. The method of claim 9, wherein moving the transportation skid from the component landing area toward the component lifting area includes activating a drive motor on the transportation skid or activating one or more winches connected between the transportation skid and the floating foundation.

12. The method of claim 9 wherein the component landing area includes at least one centralizing bore, and wherein moving the transportation skid from the transport vessel to the component landing area includes moving the transportation skid such that at least one surface engagement element on the transportation skid engages with the at least one centralizing bore in the component landing area.

13. The method of claim 9, further comprising attaching a plurality of bumpers to the component landing area prior to moving the transportation skid from the transport vessel to the component landing area on the floating foundation.

14. The method of claim 9, wherein the component lifting area includes at least one centralizing bore, and wherein the method further comprises engaging the at least one surface engagement element of the transportation skid with the at least one centralizing bore in the component lifting area.

15. The method of claim 14, when dependent from claim 10, further comprising moving the at least one rail engagement element from the deployed position to the stowed position when the transportation skid is at the component lifting area.

16. A method of installing or replacing a wind turbine component in an offshore wind turbine, the offshore wind turbine comprising:
a floating foundation having a tower interface;
a wind turbine tower connected to the floating foundation at the tower interface; and
a nacelle attached to the tower, the nacelle including an on-board crane,
the method comprising:
transporting the wind turbine component to the component lifting area according to claim 9;
attaching the wind turbine component to the on-board crane; and
lifting the wind turbine component to the nacelle using the on-board crane.

17. The method of claim 16, further comprising:
providing another transportation skid at the component lifting area;
lowering another wind turbine component from the nacelle to the another transportation skid using the on-board crane;
moving the another transportation skid from the component lifting area to the component landing area along the rail system;
connecting the another transportation skid to the lifting device on the transport vessel; and
moving the another transportation skid from the component landing area to the transport vessel using the lifting device.

18. The method of claim 17, further comprising moving the at least one rail engagement element from the deployed position to the stowed position when the another transportation skid is at the component landing area.
